(19) United States
(12) Patent Application Publication
(10) Pub. No.: US 2018/0039272 A1
(43) Pub. Date: Feb. 8, 2018

(54) INTEGRATED CONTROL/COMMAND MODULE FOR A FLYING DRONE

(71) Applicant: PARROT DRONES, Paris (FR)

(72) Inventors: Henri SEYDOUX, Paris (FR); Frédéric PIRAT, Paris (FR); Arnaud VAN DEN BOSSCHE, MARGNY LES COMPIEGNE (FR)

(21) Appl. No.: 15/672,264

(22) Filed: Aug. 8, 2017

(30) Foreign Application Priority Data
Aug. 8, 2016 (FR) 1657624

(51) Int. Cl. G05D 1/00; B64C 39/02; B64D 47/08

(52) U.S. Cl. CPC G05D 1/0088; B64D 47/08; B64C 39/024; G05D 1/0038; B64C 2201/028; B64C 2201/104; B64C 2201/141; B64C 2201/146; B64C 39/10

(57) ABSTRACT

A module for a drone that integrates an electronic circuit and one or more sensors for the attitude, altitude, speed, orientation and/or position of the drone in the same one-piece housing. The module also integrates an electronic power circuit that receives set command values prepared by the processor of the electronic circuit on the basis of the data provided by the integrated sensors and provides, as an output, corresponding signals for directly supplying current or voltage to the propulsion means of the drone and to the control surfaces.

### CROSS REFERENCE TO RELATED APPLICATIONS

This application claims priority under 35 U.S.C. §119(a) to French Patent Application Serial Number 1657624, filed Aug. 8, 2016, the entire teachings of which are incorporated herein by reference.

### BACKGROUND OF THE INVENTION

### Field of the Invention

The invention relates to remotely piloted, motorized aircraft, which are generally referred to hereinafter as “drones”, and more particularly to fixed-wing drones, in particular of the “flying wing” type.

### Description of the Related Art

Flying wing type drones include the EBEE™ model produced by SenseFly of Cheseaux-Lausanne, Switzerland, which is a professional terrain-mapping drone, and also the DISC™ model produced by Parrot S.A. of Paris, France. These drones are remotely piloted by a user who has a remote control that allows them to send piloting instructions such as climb, descent, turn to the right or to the left,

acceleration/deceleration, etc., and to view the images captured by a drone camera on a screen installed on the remote control. The drone itself generates flight control commands depending on the instructions received from the remote control, namely engine speed of the propulsion system, control-surface commands, etc. These commands are servo-controlled on the basis of data provided by multiple sensors on board the drone, such as an inertial unit (three-axis accelerometers and gyrometers), altitude sensors (barometer, ultrasound distance indicator), device for measuring air speed and/or ground speed, etc.

The invention more specifically relates to the mechanical and functional integration of the different elements on board the drone, such as various sensors, camera(s), radio reception circuits, a digital processor, circuits for generating set values for flight control and for controlling the propulsion and control-surface system(s), an autonomous piloting system, etc.

The diversity of elements generally results in a relatively complex mechanical design, with several parts and sub-assemblies to be assembled and combined inside the body of the drone in the most compact manner possible. European Patent Application publication EP2937123 describes a structure of this type for a quadcopter-type drone in which the components, sensors and cameras are attached to printed circuit boards that are in turn mounted on a supporting board carrying other components and constituent parts of the circuits of the drone on its two faces. Designing a structure of this type is a complex and therefore expensive task, just like the assembly thereof, which is very difficult to automate, even in mass production.

In addition, in the event of an accident, for example if the drone suddenly and unexpectedly falls to the ground or meets an obstacle during a flight phase, the different elements of the assembly are only protected by the shell of the drone body and may be easily damaged by the impact or the fall. In addition, if a repair is required, it is necessary to completely disassemble the drone, to replace or re-solder the damaged component (presuming that this is possible), etc.

There are compact modules that integrate a certain number of sensors, in particular gyrometric, accelerometric and barometric sensors, and potentially an imaging camera, as well as electronic circuits having a programmable data processor, into the same housing. Ample connection options make it possible to couple the module to other sensors that are not integrated in the housing (GPS, distance indicator, etc.), to circuits for processing data prepared by the processor, to a USB or Ethernet bus for transferring said data, etc. In particular, the module must be coupled to an ESC (electronic speed control) circuit for controlling the propulsion system of the drone. The ESC circuit is inserted between the propeller motor and is connected to a PWM output of the module, the PWM output providing pulse-width-modulated digital signals of the same kind as those piloting the servo-mechanisms of the control surfaces.

These modules are therefore incapable, alone, of controlling the propulsion system of the drone, and therefore do not make it possible for said drone to be integrally controlled in an autonomous manner. There is therefore the need for a structure that makes it possible to integrate, as rationally as possible, all the circuits and sensors required for carrying out the different functions of the drone, most particularly flight control.

### BRIEF SUMMARY OF THE INVENTION

The problem addressed by the present invention is to obtain an integrated module of this type, which not only incorporates all the sensors and circuits required to obtain a fully functional drone, but can also be coupled, without any intermediate means, to the propulsion system(s) of the drone and to the servomotors of the control surfaces without adding other elements or circuits.

A module of this type is intended to be able to ensure automatic piloting functions, i.e., simultaneously:
receiving piloting instructions from the remote control and/or internally generating such instructions using an integrated system for piloting in autonomous flight;
from these instructions and data provided by the sensors (sensors all integrated in the module), preparing set piloting values and converting said set values into command signals of the propulsion system and the servomotors of the control surfaces; and
directly applying these signals, for example by generating modulated power currents, without an intermediate stage between the module and the propulsion motor(s) and the servomotors.

In other words, the problem is to provide a module that makes it possible not only to process the “weak signals”, resulting from the digital processing, but also to generate currents/voltages for powering the power components such as a propeller motor/propeller motors and servomotors for controlling the control surfaces.

Additionally, the invention seeks to propose a module of this type that has a multi-platform nature, i.e. which can be used by several different types of drone alike by just requiring software to merely be adapted so that it can operate with a particular type of drone. It thus becomes possible to streamline the design and manufacture of the module, and therefore to reduce the cost price thereof, since the same module can be used in several types of drone. A significant saving can also be made with regard to the connections, which are reduced to the absolute minimum necessary.

Another advantage is that a user who owns several different drones can use a single module to fly their drones by simple, standard exchange of one apparatus for another. To do this, it is not necessary to have any aero-modelling skills, contrary to what has been proposed until now in the prior art.

Lastly, integrating all the elements allowing the drone to function in the same compact module ensures that these elements are given excellent physical protection, which is much better than if they are dispersed within the body of the drone. In addition, in the event of an accident, the intact module can be recovered by removing said module from the damaged drone and reusing it by inserting it as is into a new drone, rendering it immediately functional.

More specifically, the invention proposes an integrated control/command module for a fixed-wing flying drone comprising a propulsion system and control surfaces. This module is of a type that includes a housing in which the following are integrated: an electronic circuit comprising an automatic pilot capable of controlling the propulsion system and the control surfaces of the drone in manual assisted piloting and/or in autonomous flight, as well as a plurality of sensors for the attitude, altitude, speed, orientation and/or position of the drone; an interface for connection to the propulsion system and to the control surfaces; and an interface for connection to a battery.

The automatic pilot is capable of preparing set command values for said propulsion system and for said control surfaces, said set command values being prepared on the basis of the data provided by said plurality of sensors integrated in the housing, and external piloting instructions received by the automatic pilot from a remote control apparatus, and/or internal piloting instructions generated within the automatic pilot in autonomous flight.

In a manner characteristic of the invention, the housing further integrates an electronic power circuit that comprises said interface for connection to the propulsion system and to the control surfaces and is capable of receiving, as an input, said set command values prepared by the automatic pilot of the electronic circuit, and providing, as an output, corresponding signals for powering the propulsion system and for powering the control surfaces, the signals for powering the propulsion system being signals for directly powering the propulsion system, comprising controlled currents capable of varying the motor speed of said propulsion system.

According to various additional advantageous features:
the module further integrates at least one video camera, which is mechanically rigidly connected to the module;
the module further integrates an interface for connecting the electronic circuit to at least one radio antenna;
the module further integrates an interface for exchanging external data with said electronic circuit;
the electronic circuit is produced on a first card and the electronic power circuit is produced on a second card, which is separate from the first card;
the second card further comprises a circuit for protecting the electronic power circuit against overcurrents and/or overvoltages.

The invention also relates to a fixed-wing flying drone comprising a drone body and flight control means attached to the drone body, comprising a propulsion system and control surfaces, the body of the drone comprising a compartment that is capable of receiving, in a detachable manner, an integrated module as set out above, the inner shape of the compartment of the body of the drone being advantageously complementary to the outer shape of the envelope of the housing of the integrated module.

The invention also relates to a drone of this type, further including the integrated module as set out above.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a general view showing a fixed-wing drone of the flying wing type, which moves through the air under the control of a remote control apparatus.

FIG. 2 is a highly simplified diagram of the different functional blocks of the drone and of the remote control apparatus.

FIG. 3 is an exploded perspective view of the body of the drone, showing the integrated control/command module according to the invention, when removed from the body of the drone, and a cover for closing the module compartment.

FIGS. 4a, 4b and 4c are larger-scale views of the integrated control/command module of the invention, these being a three-quarter rear perspective view, a three-quarter front perspective view and a rear elevation, respectively.

FIG. 5 is a side elevation of the integrated module of the invention, schematically showing the different elements and sensors integrated in said module.

FIG. 6 is a functional block diagram of an automatic pilot integrated in the module according to the invention.

### DETAILED DESCRIPTION OF THE INVENTION

An embodiment of the device of the invention will now be described.

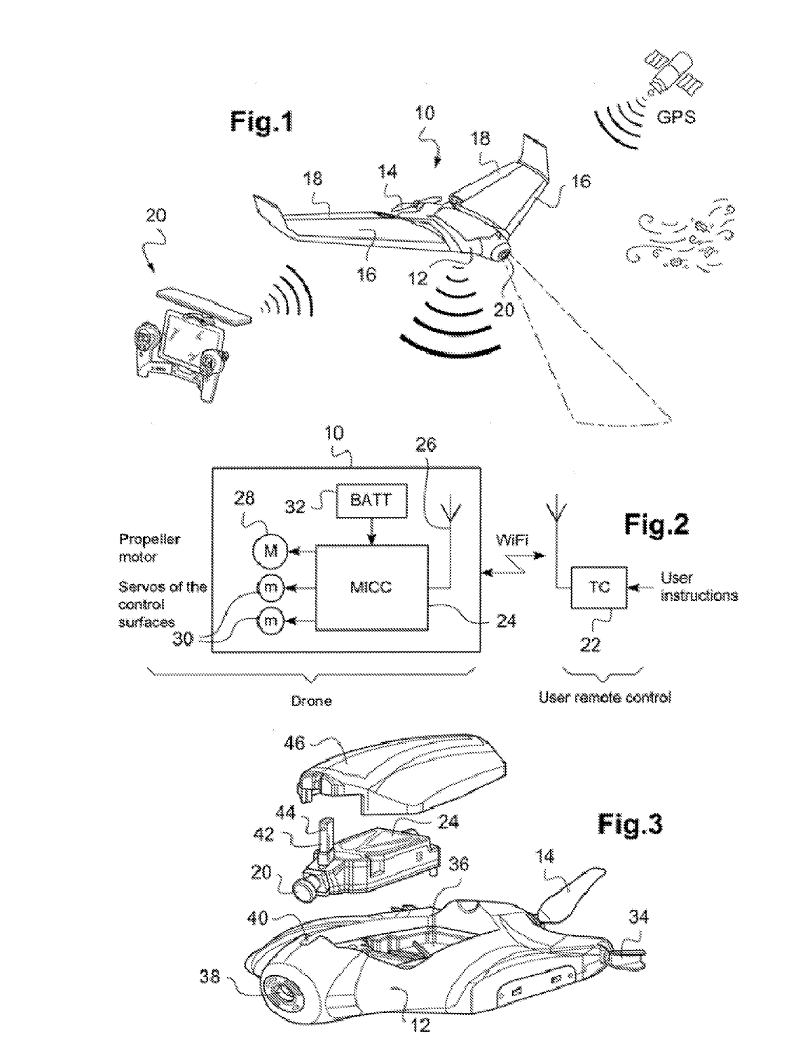

FIG. 1 shows a drone 10, in this case a fixed-wing drone of the flying wing type This drone 10 comprises a drone body (fuselage) 12 that is provided at the rear with a propulsion system consisting, for example, of a motor and a propeller 14, and is provided at the sides with two wings 16, said wings extending the drone body 12 in the “flying wing” configuration shown. On the trailing-edge side, the wings 16 are provided with control surfaces 18 that can be oriented by means of servomotors in order to control the trajectory of the drone. The drone is also provided with a front-view camera 20 for capturing an image of the landscape towards which the drone is moving.

The drone 10 is piloted by a remote control apparatus 22 provided with a touch screen configured to display the image captured by the camera 20, and with various piloting controls that are available to the user. The remote control apparatus 22 is a digital tablet having a touch screen has been mounted. The remote control apparatus 22 is also provided with means for radio contact with the drone, for example of the local WiFi (IEEE 802.11) network type, for the bidirectional exchange of data, namely from the drone 10 to the remote control apparatus 22, in particular by transmitting the image captured by the camera 20, and from the remote control apparatus 22 to the drone in order to send piloting instructions to said drone. The user can also use piloting immersion goggles, referred to as first person view (FPV) goggles.

FIG. 2 is a highly simplified functional diagram of the assembly formed by the drone 10 and the remote control apparatus 22. In a manner characteristic of the invention, the drone implements an integrated control/command module MICC 24, the mechanical and functional aspects of which will be described in detail below. This integrated module 24 is connected to one or more WiFi antennas 26 of the drone, to the propulsion system 28 for driving the propeller 14 of the drone, and to the servomotors 30 for controlling the control surfaces 18 for the aerodynamic control of the trajectory of the drone.

In the example shown of a drone of the “flying wing” type, there is one propulsion system 28 and two servomotors 30, but this is just an example, and a drone may be provided with a plurality of propulsion propellers and therefore with a plurality of corresponding propulsion systems, and with additional control surfaces, for example in the case of a drone provided with a fin at the rear.

The drone 10 also incorporates a power battery 32 that provides the voltages required for the various components included in the module 24, as well as the voltages and currents required for driving the propulsion system 28 and the servomotors 30.

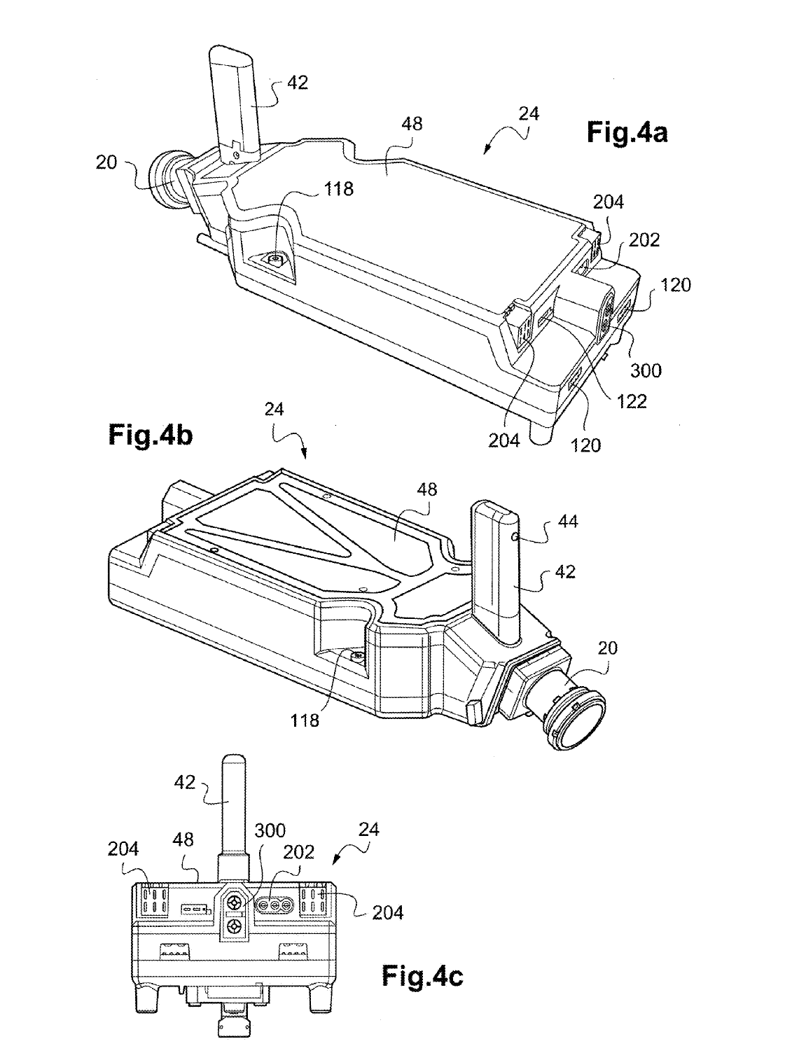

With reference to FIGS. 3, 4a, 4b and 4c, the mechanical aspects of the integrated module 24 will now be described.

FIG. 3 is an exploded view showing the drone body 12, shown here with the wings removed, with only the vanes 34 for controlling the control surfaces being shown, the position of which is controlled by the respective servomotors 30 in FIG. 2.

The drone body 12 comprises a central compartment 36 into which the module 24 is inserted, the compartment 36 and the module 24 having corresponding shapes to make it easier for said module to be slotted into said compartment. Once the integrated module 24 is positioned in the compartment 36, the drone body is closed again by a cover 46 that makes it possible for the drone to retain its aerodynamic properties and also makes it possible to protect the module 24 against possible impacts and falls.

The drone body 12 comprises, at the front, an opening 38 through which the lens of the camera 20 carried by the module 24 passes.

It also comprises a slot 40 that allows a superstructure element 42 to pass and emerge therethrough, which element projects in the radial direction, perpendicularly to the drone body 12, and the exterior of which is in the shape of a flattened tubular part extending approximately in a longitudinal median plane of the drone body 12.

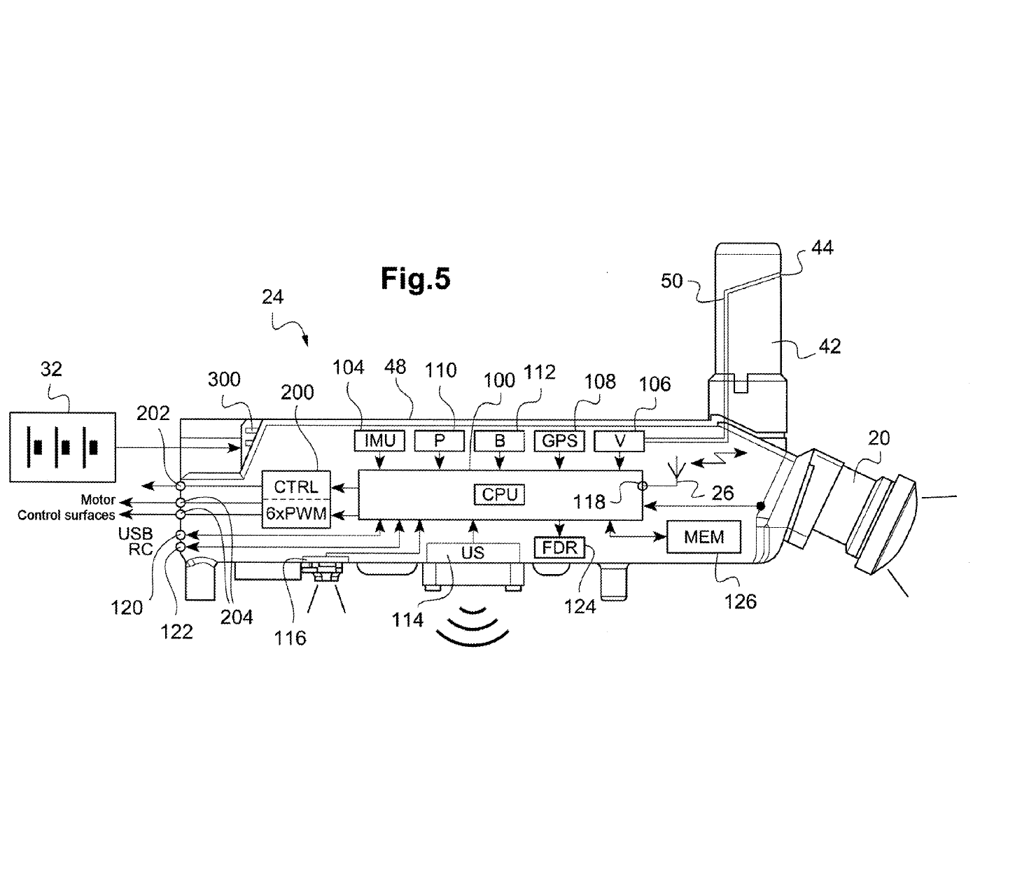

One of the functions of the superstructure element 42 is for it to be used as a Pitot probe to measure the air speed, said element being provided, at the front, with a dynamic-pressure air intake that allows the speed of the drone to be measured compared with the air (relative wind). As shown in FIGS. 4a, 4b, 4c and 5, the module 24 is in the form of a housing 48, for example a one-piece housing, which integrates all the elements and circuits required for piloting the drone therein, with the connections being reduced to a minimum, as will now be explained in detail.

More specifically, FIG. 5 schematically shows the different elements and sensors integrated in the housing 48 of the module 24 of the invention.

The integrated module first comprises an electronic circuit 100 that centralizes all the “low-current” circuits and components and implements an automatic pilot system that executes all the digital calculations required for controlling the propulsion system and the control surfaces of the drone, which allow the drone to fly. The electronic circuit 100 supports a certain number of sensors, for example:
an inertial unit (IMU) 104 comprising three-axis accelerometers and gyrometers;
a sensor 106 for measuring the air speed of the drone, connected to the dynamic pressure intake 44 of the superstructure element 42 by means of a pipe 50;
a GPS module 108 that provides the absolute position of the drone in a geographical reference point;
a barometric sensor 110 that makes it possible to determine the variations in altitude of the drone (instantaneous variations and variations relative to a known starting altitude);
a magnetometric sensor 112 that provides the orientation of the drone relative to the true north;
an ultrasound telemetric sensor 114 that provides the altitude of the drone relative to the terrain over which the drone is flying; and
a vertical-view camera 116 that provides an image of the terrain over which the drone is flying and makes it possible to determine, by image processing, the speed of the drone relative to this terrain (ground speed, by contrast with the air speed provided by the sensor 106).

As regards the front camera 20, it is mechanically supported by the integrated control/command module 24, and is connected to the electronic circuit 100 inside the housing 48 to make it possible to process and record the data provided by the image sensor of the camera. The processing involves, for example, real-time, software-generated windowing of the image provided by a high-definition wide-angle camera provided with a fisheye-type hemispheric-field lens covering a field of approximately 180°, and this technology is used in particular in the Disco apparatus mentioned above and described in EP 2 933 775 A1 (Parrot).

The electronic circuit 100 also supports:
one or more inputs 118 for coupling to a radio antenna 26 that allows bidirectional communication with the remote control apparatus;
one or more USB sockets 120 that can be used for various purposes, for example for retrieving videos or photos taken by the camera of the drone, for testing digital circuits of the drone, for updating firmware of the unit 100, for connecting a USB stick used as an auxiliary memory for storing videos or photos, or for connecting a 3G/4G dongle for direct connection to a cellular network that allows items to be moved to a remote cloud server with which the drone is registered, a certain number of piloting operations and calculations, image processing, etc. instead of these being executed within the on-board processor, or for transferring the image sequences taken by the camera to said cloud server;
a “radio control” socket 122 of the type commonly used with RF modelling receivers if the user wishes to pilot the drone using an information transmission channel other than the WiFi connection of the antenna 26;
an auxiliary memory 124 forming a flight data recorder (FDR);
potentially, an additional memory 126 for storing in particular images taken by the front camera.

Moreover, the module 24 integrates an electronic power circuit, also referred to as a power card 200, comprising circuits that allow the propulsion system to be directly powered, which circuit is connected to a socket 202 that makes it possible to supply corresponding high currents (typically a 15 amp three-phase power supply).

The electronic power circuit 200 also comprises a plurality of power outputs 204 for connecting servomotors for controlling the control surfaces. In the example shown, the integrated module 24 is provided with six outputs of this type, of which only two are used in this particular case of a flying wing only comprising two control surfaces 18 to be controlled. The control is operated by pulse width modulation PWM, in a manner that is conventional per se.

The integrated module 24 is also provided with a connector 300 for connection to the battery 32, for example an XT60-type connector, which is a type that is widely used in the field of modelling.

With regard to the connections, the integrated module 24 is as shown in FIGS. 4a, 4b and 4c, comprising:
two connectors 118 at the front for connecting the RF antennas;
two USB sockets 120 at the rear;
an RC socket 122 at the rear;
a socket 202 for connecting to the propulsion system;
six PWM outputs for powering servomotors, two of which are used to control the control surfaces for controlling trajectory; and
a battery connector 300.

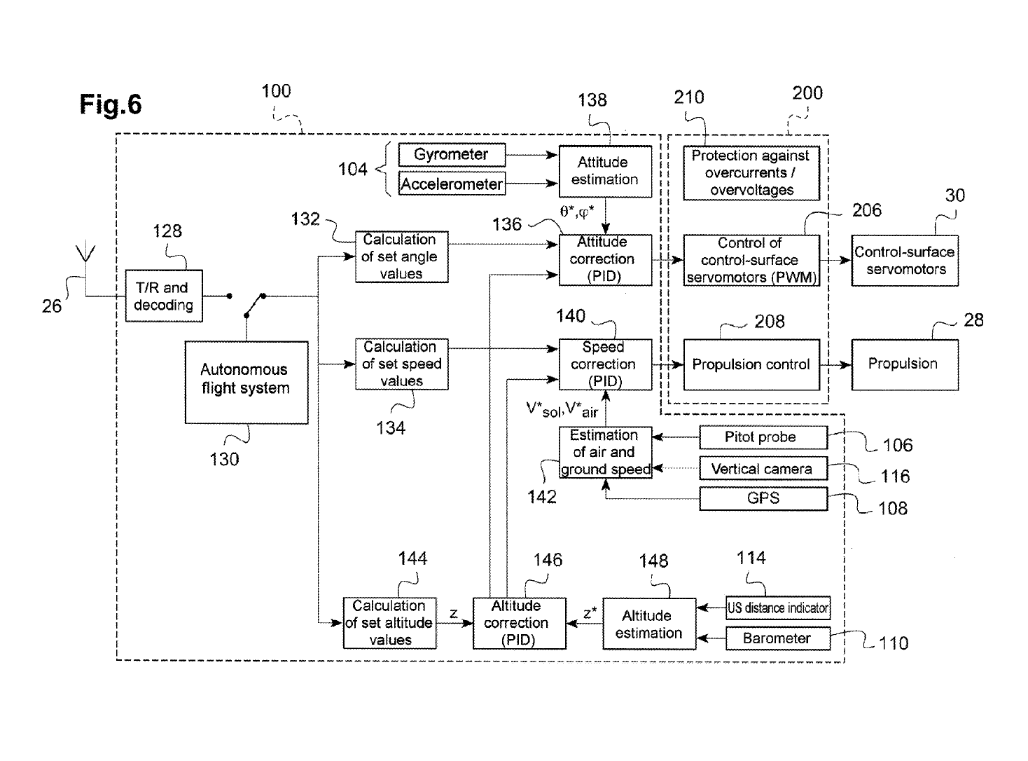

With reference to the block diagram in FIG. 6, the various components of an automatic pilot system of the drone that is implemented in the electronic unit 100, which components are integrated in the module according to the invention, will now be described. The automatic pilot system is capable of controlling the propulsion system and the control surfaces of the drone during manual assisted piloting of the drone and/or during autonomous flight of the drone.

The piloting instructions originating from the user remote control in assisted piloting mode (“external instructions”) are received and decoded by a decoding module 128, which provides instructions such as “turn right” or “turn left”, “climb” or “descend”, “accelerate” or “decelerate”. These instructions are, for example, proportional instructions generated by means of controllers or commands such as joysticks of the remote control apparatus 22 on the basis of the change that the user wishes to impart on the trajectory of the drone.

In autonomous flight mode, the autonomous flight module 130 of the automatic pilot 100 itself generates instructions (“internal instructions”) corresponding to an imposed trajectory such as automatic take-off, automatic landing, orbit around a predetermined point, etc. It is also noted that, in one particular “overpiloting” mode, the user has the option of adding their own (external) instructions to those (internal) instructions automatically generated by the autonomous flight module 130, for example to intervene in a trajectory imposed by the autonomous flight module 130 in order to correct this trajectory.

The external and/or internal piloting instructions are applied to a module 132 for calculating set values for attitude angles of the drone (set values θ for the pitch angle and φ for the roll angle), to a module 134 for calculating set values for the speed of the drone (set speed value V), and to a module 144 for calculating set values for the altitude of the drone (set altitude value z).

From i) external and/or internal piloting instructions such as those defined above and from ii) a model for the aerodynamic behaviour of the drone in flight, which has been determined in advance and is stored in the memory, each of the modules 132, 134, 144 determine corresponding set values, for the pitch angle θ and roll angle φ, for speed V, and for altitude z, respectively.

For an internal or external turning instruction, the module 132 for calculating set angle values determines at least one set angle value such as the roll φ, a set pitch value θ being produced by an altitude correction module 146, which will be described in detail below. Indeed, a turning instruction needs to have an effect on the motor and on the control surfaces because the drone will lose speed when turning. If the user does not give an instruction to change speed or altitude along with the turning instruction, in order to compensate for the loss of altitude the altitude correction module 146 determines set pitch and speed values, which are calculated from the last instruction before the turning instruction in order to keep the drone at a constant speed and altitude during turning.

The set values for pitch angle θ and roll angle φ produced by the module 132 and by the module 146 are applied to an attitude correction module 136 of the PID-controller type. This module 136 corrects the set values provided by the modules 132 and 146 on the basis of the instantaneous effective attitude of the drone (pitch angle θ* and roll angle φ*), determined by an attitude estimation module 138 from gyrometric and accelerometric data provided by the sensors of the inertial unit of the drone 104.

The resulting corrected set values produced at the output of the module 136 are transmitted to a power module 206 for controlling the servomotors of the control surfaces. This module generates controlled PWM signals, which are applied to different servomotors 30 for driving the control surfaces.

For an internal or external instruction to increase/reduce speed, the module 134 for calculating set speed values determines a set speed value V. A second set speed value V is determined by the above-mentioned altitude correction module 146 (module which also determines the set pitch value θ).

The set speed values V produced by the module 134 and by the module 146 are applied to a speed correction module 140 of the PID-controller type (the two set speed values being combined with correction priority given to maintaining the altitude). This module 140 corrects the set speed value V provided by the modules 134 and 146 and on the basis of the instantaneous ground speed V*_{ground} and air speed V*ₐᵢᵣ of the drone, as determined by a module 142 for estimating air and ground speeds of the drone from data provided by the Pitot probe 106 (for the air speed) and by analysing the image from the vertical camera and by means of the data from the GPS module 62 (for the ground speed).

The resulting corrected set speed values produced at the output of the module 140 are transmitted to a power module 208 for controlling the propulsion unit 28. This module 208 generates a controlled current that allows the speed of the propulsion unit 28, and therefore the thrust of the propeller 14, to be varied in the desired manner.

The internal or external instructions to climb/descend and/or to turn are applied to the module for calculating the set altitude value 144, which provides a set altitude value z for the drone. This set value z is applied to the altitude correction module 146, which is a module of the PID-controller type, for example. This module 146 corrects the set altitude value z on the basis of the effective instantaneous altitude z* of the drone, determined by an altitude estimation module 148 from data provided by the ultrasound distance indicator and by the barometric sensor. Here again, when a speed instruction is given, the altitude correction module 146 and attitude correction module 136 calculate the set values in order to give priority to maintaining the altitude and the yaw of the drone.

The resulting corrected set altitude correction values provided by the module 146 include a set pitch value θ and a set speed value V, since the increase in the altitude of the drone is produced by increasing the motor speed and pulling the drone up, and vice versa for reducing the altitude (a loss of altitude may also result from a turning instruction, as explained above, and this loss of altitude needs to be compensated for).

In a particular embodiment, the automatic pilot modules 100 are implemented by means of software. The modules are provided in the form of software applications stored in a memory of the drone 10 and executed by a processor of the drone 10. In a variant, at least one of the modules is a specific electronic circuit or a programmable logic circuit.

The various functional modules 128 to 148 that have just been described, as well as the sensors 104, 106, 108, 110, 114 and 116 used by these modules, are all positioned within the electronic circuit 100.

By contrast, the modules 206 and 208 for controlling the servomotors of the control surfaces and for controlling the propulsion system are positioned within the electronic power circuit 200, which is separate from the electronic circuit 100. This makes it possible to electrically separate the circuits that only process weak signals (on the circuit 100) from those processing power signals (on the card for the circuit 200).

The circuit 200 is advantageously provided with its own module 210 for protecting against overcurrents and/or overvoltages, in particular for protecting against potential short-circuits at the connectors to the servomotor or to the propeller motor.

It is thus ensured that the power circuits are protected in an autonomous manner, independently of the electronic circuit 100, which remains confined to recording and processing weak signals that are not liable to cause short-circuits or other destructive anomalies of this type.

Having thus described the invention of the present application in detail and by reference to embodiments thereof, it will be apparent that modifications and variations are possible without departing from the scope of the invention defined in the appended claims as follows:

What is claimed is:

1. An integrated control/command module for a fixed-wing flying drone that includes a propulsion system and control surfaces, said module comprising:
a housing including an electronic circuit comprising an automatic pilot capable of controlling the propulsion system and the control surfaces of the drone in manual assisted piloting and/or in autonomous flight, and a plurality of sensors for the attitude, altitude, speed, orientation and/or position of the drone;
an interface for connection to the propulsion system and to the control surfaces and an interface for connection to a battery, wherein the automatic pilot prepares set command values for said propulsion system and for said control surfaces, said set command values being prepared on the basis of the data provided by said plurality of sensors integrated in the housing and external piloting instructions received by the automatic pilot from a remote control apparatus, and/or internal piloting instructions generated within the automatic pilot in autonomous flight; and,
an electronic power circuit including said interface for connection to the propulsion system and to the control surfaces and receives, as an input, said set command values prepared by the automatic pilot of the electronic circuit, and provides, as an output, corresponding signals for powering the propulsion system and for powering the control surfaces, said signals for powering the propulsion system being signals for directly powering the propulsion system, comprising controlled currents capable of varying the motor speed of said propulsion system.

2. The module of claim 1, wherein the module further includes at least one video camera that is mechanically rigidly connected to the module.

3. The module of claim 1, wherein the module further includes an interface connecting the electronic circuit to at least one radio antenna.

4. The module of claim 1, wherein the module further includes an interface exchanging external data with said electronic circuit.

5. The module of claim 1, wherein the electronic circuit is produced on a first card and the electronic power circuit is produced on a second card, which is separate from the first card.

6. The module of claim 5, wherein the second card further comprises a circuit protecting the electronic power circuit against overcurrents and/or overvoltages.

7. A fixed-wing flying drone comprising:
a drone body; and
a flight controller attached to the drone body, comprising a propulsion system and control surfaces,
wherein the body of the drone comprises a compartment receiving, in a detachable manner, an integrated module comprising:
a housing including an electronic circuit comprising an automatic pilot capable of controlling the propulsion system and the control surfaces of the drone in manual assisted piloting and/or in autonomous flight, and a plurality of sensors for the attitude, altitude, speed, orientation and/or position of the drone;
an interface for connection to the propulsion system and to the control surfaces and an interface for connection to a battery, wherein the automatic pilot prepares set command values for said propulsion system and for said control surfaces, said set command values being prepared on the basis of the data provided by said plurality of sensors integrated in the housing and external piloting instructions received by the automatic pilot from a remote control apparatus, and/or internal piloting instructions generated within the automatic pilot in autonomous flight; and,
an electronic power circuit including said interface for connection to the propulsion system and to the control surfaces and receives, as an input, said set command values prepared by the automatic pilot of the electronic circuit, and provides, as an output, corresponding signals for powering the propulsion system and for powering the control surfaces, said signals for powering the propulsion system being signals for directly powering the propulsion system, comprising controlled currents capable of varying the motor speed of said propulsion system.

8. The drone of claim 7, wherein the inner shape of the compartment of the body of the drone is complementary to the outer shape of the envelope of the housing of the integrated module.

9. The drone from claim 8, wherein the module further includes:
at least one video camera that is mechanically rigidly connected to the module;
an interface connecting the electronic circuit to at least one radio antenna; and,
an interface exchanging external data with said electronic circuit;
wherein the electronic circuit is produced on a first card and the electronic power circuit is produced on a second card, which is separate from the first card; and,
wherein the second card further comprises a circuit protecting the electronic power circuit against overcurrents and/or overvoltages.
